(19) United States
(12) Patent Application Publication
(10) Pub. No.: US 2003/0098636 A1
(43) Pub. Date: May 29, 2003

(54) Revolutionary connections for spark plugs and spark plug wires

(76) Inventors: Si-Nin Quan, San Jose, CA (US); Judy Fei-Man Quan, San Jose, CA (US)

Correspondence Address: Si-Nin Quan, 3186 Yakima Circle, San Jose, CA, 95121, US

(21) Appl. No.: 09/995,872

(22) Filed: Nov. 29, 2001

(51) Int. Cl. H01R 13/44

(52) U.S. Cl. 313/11; 439/125

(57) ABSTRACT

With two features of positive lock and self-pop-up, the invention provides simple procedure for connecting and disconnecting spark plugs and spark plug wires, a union of prevention and ensurer.

### FEDERALLY SPONSORED RESEARCH

Not Applicable

### SEQUENCE LISTING OR PROGRAM

Not Applicable

### BACKGROUND OF THE INVENTION

This invention relates to secondary ignition system for internal combustion engines, specifically to an improved positive locking function and easy removal for conventional spark plugs and spark plug wires connections.

Variety of connections have been used in spark plugs and plug wires couplings, the most popular style is click-in, push to connect and pull to disconnect. Push to connect will create confushion sometimes whether said connections are secured or just being snug? Bench test reveals free spinning of components from said connections even though they are tight and secured. Self-seperation occurs occasionally due to aging, repeated services, thermal cycles, vibration and high voltage conduction. If said self-seperation should happen, it will cause pollution, poor performance and possibly internal engine damage. Pull to disconnect is another negative factor, when pulling is exercised, there is tendency of tearing components apart, rubber boot being torn possibly damaging the core in the plug wire, misfire would happen. In addition to surrounding high temperature, confined space, service personnel always have to face frustration, struggle or even minor bodily injuries in the field of servicing said connections. Numerous prior arts offered remedies, particularly U.S. Pat. No. (5,332,394), Frost July, 1994 and U.S. Pat. No. (4,810,198), Sturdevan March, 1989. Since all connections are couplers, concentrating upon one end will not reach ultimacy, the essence of my invention is synchronizing the other end which is the spark plug tip, an all-time solution.

### SUMMARY

The invention will bring maintenance, services and repairs to a new boundary by providing simple, effortless procedure for servicing spark plugs and plug wires connections. The positive locking feature ensures an EPA issue-nonmisfiring, the self-pop-up released feature is a phenomenon to all related service personnel.

### DRAWINGS

Drawing figures

FIG. 1 shows conventional spark plug.

FIG. 2 shows new configuration of spark plug tip.

FIG. 3 shows top view of trust washer with inside diameter ±6 mm, outside diameter ±9 mm, due to various spark plug tip design, inside diameter should be recalibrated to fit individual application.

FIG. 4 shows compressible spring with free height ±14 mm, outside diameter ±9 mm.

FIG. 5 shows spark plug tip with built-in slot-pins ±9 mm in length.

FIG. 5A shows top view of spark plug tip with built-in slot-pins.

FIG. 6 shows new configuration of spark plug tip after assembly.

FIG. 7 shows conventional plug wire with stationary rubber boot.

FIG. 7A shows built-in metal clip 14, rubber boot not shown.

FIGS. 8-8A show front and rear views of new embodiment with predetermined slots and omission of metal clip 14.

FIG. 8B shows top view of FIGS. 8 and 8A.

FIG. 9 shows adaptor for modified spark plug tip and conventional spark plug wire, an alternative embodiment.

FIG. 10 shows new configuration after assembly, a preferred embodiment.

FIG. 11 shows adaptor for modified spark plug tip and conventional spark plug wire metal clamp, an alternative embodiment.

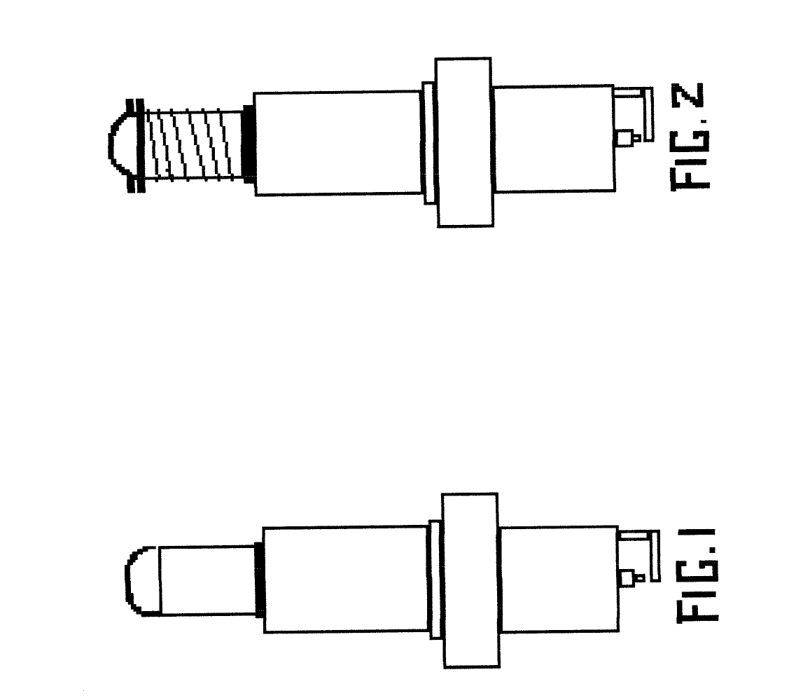

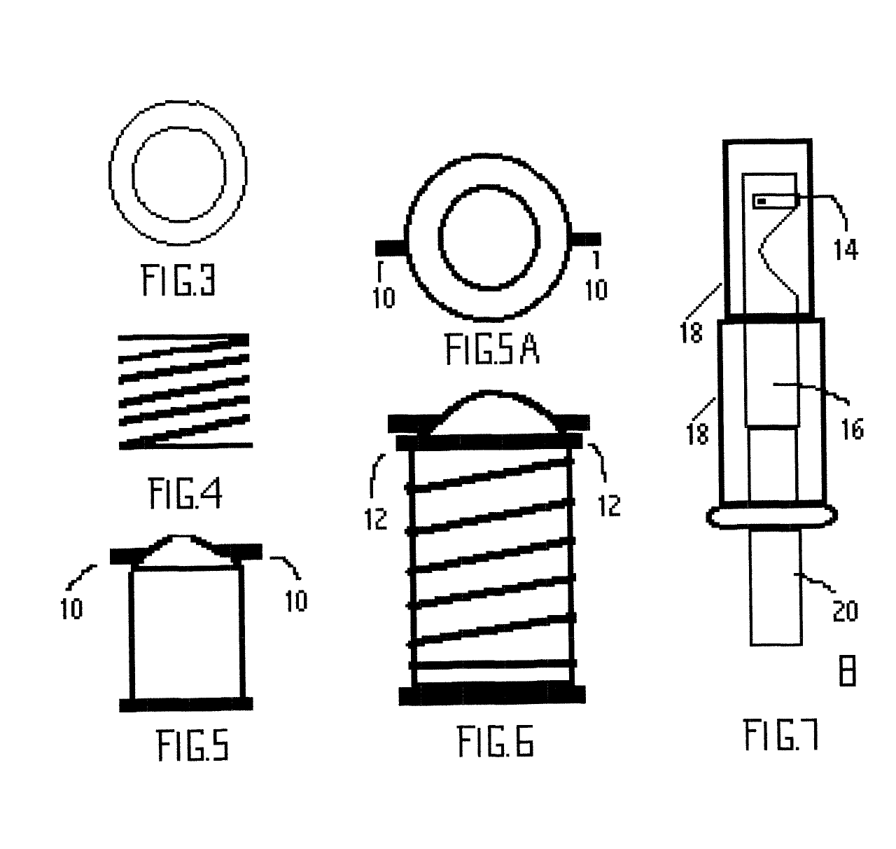

### REFERENCE NUMERALS IN DRAWINGS

| | | | |
|---|---|---|---|
| 10 | built-in slot-pins | 12 | thrust washer |
| 14 | metal clip | 16 | metal clamp |
| 18 | rubber boot | 20 | plug wire (partial) |
| 22 | built-in slots | 24 | adaptor |

### DESCRIPTION

### Preferred Embodiment

Drill a predetermined hole through upper portion of a conventional spark plug tip, install compressible spring over plug tip, put thrust washer on top of said spring, insert a predetermined slot-pin or cotter-pin through the hole to hold said washer and spring in place. The said assemblage can also be put together with built-in slot-pins in manufacturing process of spark plugs.

The spring clip in conventional plug wire metal clamp will be omitted, predetermined slots are built in metal clamp, recommend material for modified metal clamps be superior than excisting counterpart. Rubber boot will be made to slide along plug wire instead of stationary, same modification can be applied to Hemi style long-reached plug wire and Distributorless individual ignition coil design.

### Alternative Embodiment

An adaptor can be built with conventional plug tip at one end, which will fit conventional plug wire metal clamp, while the other end with predetermined slots will fit in spring-loaded plug tip. The advantage here is no modification needed for conventional plug wires, but non locking character still exists.

### OPERATION

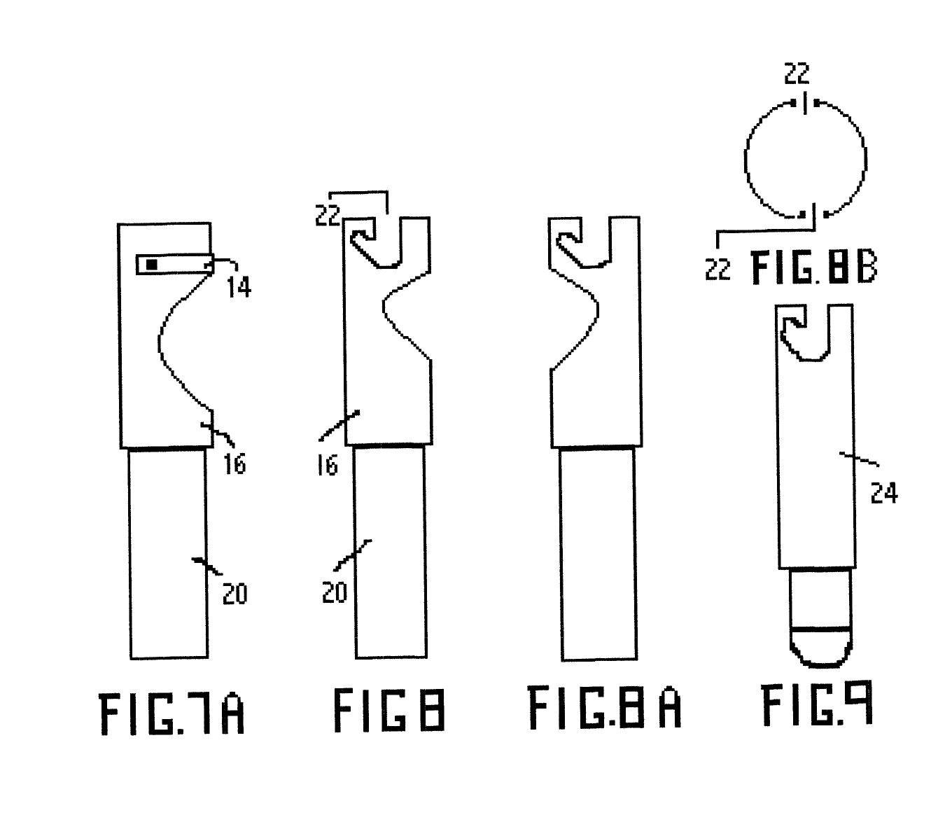

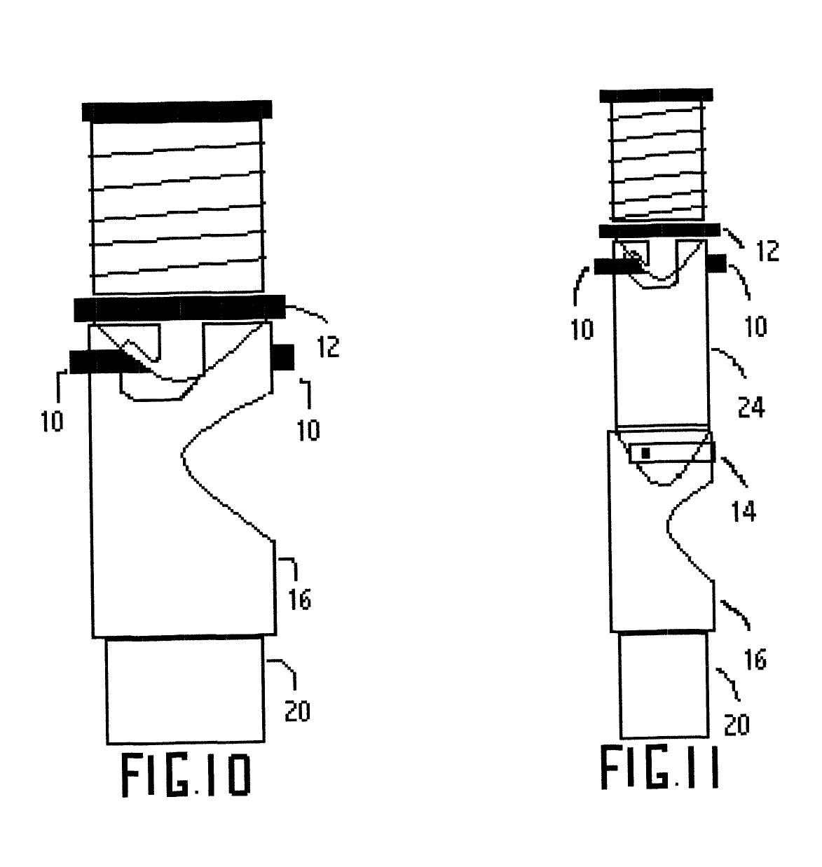

The invention provides simple steps to connect and disconnect spark plug wires from spark plugs. For removal, slide rubber boot 18 (FIG. 7) upward to expose enough metal clamp of plug wire 20 (FIG. 8) press said metal clamp down, turn counter clockwise to release, since plug tip is spring-loaded, said metal clamp will be pushed out after it clears the slot-pins. Compare to what mechanics are doing these days like twisting, pulling and yanking, this self-pop-up is a phenomenon. For installation, hold said metal clamp against matching slot-pins (can be felt easily ), once metal clamp clears said slot-pins, press down and turn clockwise to lock, the spring will urge upon said metal clamp, forming a positive locking position, slide down said rubber boot firmly. With conventional snap and pull connections, even experienced mechanic can't be certain said connections are secured or just being snug, now they are black and white!

We claim:

1. A connection of the type comprising a modified spark plug tip and a modified spark plug wire metal clamp, the improvement wherein said connection has positive lock and easy disconnection features.

2. The connection of claim 1 wherein said spark plug tip has predetermined pins to which metal clamp of said spark plug wire can hook on.

3. The spark plug tip of claim 2 wherein has predetermined spacer and flexible means which are positioned by said pins.

4. The connection of claim 1 wherein said spark plug wire has predetermined slots built-in metal clamp.

5. The metal clamp of claim 4 wherein has sliding rubber boot.

6. A connection of the type comprising a modified spark plug tip and a modified spark plug wire metal clamp, characterized in easy junction.

7. The connection of claim 6 wherein said spark plug tip has predetermined dowels to which metal clamp of said spark plug wire can hook on.

8. The spark plug tip of claim 7 wherein has predetermined washer and compressible means which are held down by said dowels.

9. The junction of claim 6 wherein said spark plug wire metal clamp has predetermined grooves.

10. The metal clamp of claim 9 wherein has movable rubber boot.
